(19) United States
(12) Patent Application Publication
(10) Pub. No.: US 2020/0182148 A1
(43) Pub. Date: Jun. 11, 2020

(54) HYBRID COMPRESSED AIR ENERGY STORAGE SYSTEM

(71) Applicant: Dresser-Rand Company, Olean, NY (US)

(72) Inventors: Joseph Williams, Kirkland, WA (US); Jason M. Kerth, Houston, TX (US)

(21) Appl. No.: 16/792,684

(22) Filed: Feb. 17, 2020

Related U.S. Application Data
(63) Continuation-in-part of application No. 15/602,179, filed on May 23, 2017.
(60) Provisional application No. 62/346,587, filed on Jun. 7, 2016.

(51) Int. Cl. F02C 6/16; F02C 7/14

(52) U.S. Cl. CPC F02C 6/16; F05D 2260/42; F02C 7/14

(57) ABSTRACT

A hybrid compressed air energy storage system is provided. A heat exchanger 114 extracts thermal energy from a compressed air to generate a cooled compressed air stored in an air storage reservoir 120, e.g., a cavern. A heat exchanger 124 transfers thermal energy stored in a thermal storage device 130 to compressed air conveyed from reservoir 120 to generate a heated compressed air. An expander 140 is solely responsive (no heat is introduced by way of a combustor) to the heated compressed air to produce power and generate an expanded air. Expander 140 being solely responsive to heated compressed air by heat exchanger 124 is effective to reduce a temperature of the expanded air by expander 140, and thus a transfer of thermal energy from an expanded exhaust gas received by a recuperator 146 (used to heat the expanded air by the first expander) is effective for reducing waste of thermal energy in exhaust gas cooled by recuperator 146.

### CROSS-REFERENCE TO RELATED APPLICATIONS

This application is a continuation-in-part of non-provisional U.S. patent application Ser. No. 15/602,179, filed May 23, 2017, and further claims the benefit of U.S. provisional patent application Ser. No. 62/346,587, filed Jun. 7, 2016. The foregoing patent applications are incorporated by reference in their entirety into the present application to the extent consistent with the present application.

### BACKGROUND

### 1. Field

Disclosed embodiments are directed to a Compressed Air Energy Storage (CAES) system, and, more particularly, to a hybrid CAES system incorporating aspects of both an adiabatic CAES system and a diabatic CAES system.

### 2. Description of the Related Art

Compressed air energy storage (CAES) systems store excess power available in an electrical grid during off-peak load periods and in turn supply electricity to the electrical grid during peak load periods. The CAES systems produce stored energy by compressing and storing a gas during the off-peak load periods and generate electricity by expanding the stored compressed gas during the peak load periods.

### BRIEF DESCRIPTION OF THE DRAWINGS

The present disclosure may be best understood from the following detailed description when read with the accompanying figures (FIGs.). It is emphasized that, in accordance with standard practice in the field, various features may not be drawn to scale. In fact, the dimensions of the various features may be arbitrarily increased or reduced for clarity purposes.

FIG. 1 shows a schematic diagram of one non-limiting embodiment of a disclosed hybrid CAES system.

FIG. 2 shows a schematic diagram of another non-limiting embodiment of a disclosed hybrid CAES system.

FIG. 3 shows a schematic diagram of yet another non-limiting embodiment of a disclosed hybrid CAES system.

FIG. 4 shows a flow chart of one nonlimiting embodiment of a method for storing and recovering energy with a disclosed hybrid CAES system.

### DETAILED DESCRIPTION

Adiabatic CAES produces no carbon emissions or other pollutants, but also produces relatively less power than a diabatic system due to reduced temperatures into the expanders. By way of comparison, diabatic CAES produces substantially more power than adiabatic CAES due to the relatively higher temperatures into the expanders, but diabatic CAES produces carbon emissions and other pollutants. Disclosed embodiments of a hybrid system, involving aspects of adiabatic CAES and diabatic CAES, produce less carbon and pollutant emissions than would be produced by a diabatic system (alone) while still producing significantly more power than would be produced by an adiabatic system (alone).

It is to be understood that the following disclosure discloses several exemplary embodiments for implementing different features, structures, and/or functions. Exemplary embodiments of components, arrangements, and configurations are described below to simplify the present disclosure; however, these exemplary embodiments are provided merely as examples and are not intended to limit the scope of the disclosure. Additionally, the present disclosure may repeat reference numerals and/or letters in the various exemplary embodiments and across the FIGs. provided herein. This repetition is for the purpose of simplicity and clarity and does not in itself dictate a relationship between the various exemplary embodiments and/or configurations discussed in the various FIGs. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be arranged in various ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the disclosure, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

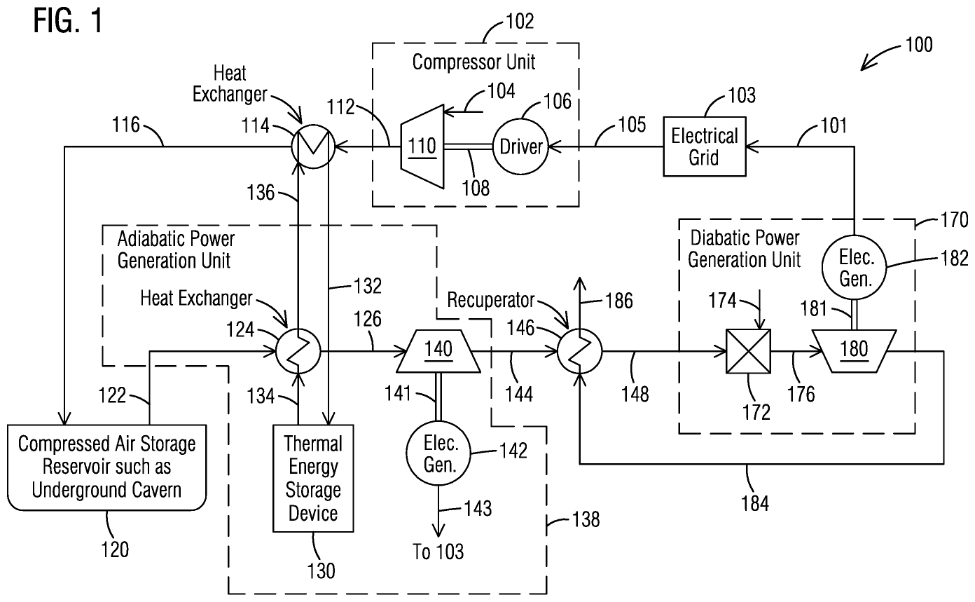

FIG. 1 shows a schematic diagram of one non-limiting embodiment of a disclosed hybrid CAES system 100. The hybrid CAES system 100 may be a hybrid adiabatic-diabatic CAES system comprising synergistic aspects of an adiabatic CAES system and a diabatic CAES system. The hybrid CAES system 100 may include one or more adiabatic power generation units 138.

In one non-limiting embodiment, the hybrid CAES system 100 may include one or more compressor units 102. Each compressor unit 102 may include one or more drivers 106 and one or more compressors 110. The driver 106 may power or drive the compressor 110 and may be coupled to the compressor 110 by one or more driveshafts 108. The compressor unit 102 may receive and compress a process gas, such as air, via line 104 and may discharge a compressed process gas, such as compressed air, via line 112 during off-peak load periods. The process gas may be or include one or more working fluids or refrigerants. For example, an illustrative process gas may be or include, but is not limited to, air, nitrogen, oxygen, argon, carbon dioxide, methane, ethane, propane, or any mixture thereof. In one or more examples, the compressor 110 may receive and compress ambient air via line 104 and may discharge compressed air via line 112. The driver 106 may be or include, but is not limited to, one or more electric motors, one or more turbines or expanders, or a combination thereof. The compressor 110 may be or include, but is not limited to, one or more of a supersonic compressor, a centrifugal compressor, an axial flow compressor, a reciprocating compressor, a rotary screw compressor, a rotary vane compressor, a scroll compressor, or a diaphragm compressor.

Although one compressor unit 102 containing one driver 106 and one compressor 110 are depicted in FIG. 1, any number of the compressor units 102 containing one or more drivers 106 and one or more compressors 110 may be used in a compressor train, not shown, in the hybrid CAES system 100. For example, the hybrid CAES system 100 may include, but is not limited to, 2, 3, 4, 5, 6, 7, 8, or more compressor units 102 containing one or more drivers 106 and one or more compressors 110.

In one or more embodiments, not shown, the hybrid CAES system 100 may include a first driver that may drive a first compressor, a second driver that may drive a second compressor, a third driver that may drive a third compressor, and a fourth driver that may drive a fourth compressor. In some examples, each pair of the driver 106 and the compressor 110 may be disposed together in a hermetically sealed casing (not shown). Without limitation, the compressor units 102 containing one or more drivers 106 and one or more compressors 110 may be a DATUM centrifugal compressor unit, commercially available from Dresser-Rand, a Siemens business. In another example, one or more compressors 110 may be or include a DATUM-S compressor, also commercially available from Dresser-Rand.

One or more heat exchangers 114 may receive the compressed air via line 112 discharged by the compressor 110. In one non-limiting embodiment, the compressed air may have temperatures in a range from approximately 500° F. to approximately 550° F. The heat exchanger 114 may extract thermal energy (e.g., heat of compression) from the compressed air and may discharge a cooled compressed air via line 116. One or more air storage reservoirs 120 may receive the cooled compressed air via line 116 from the heat exchanger 114. The cooled compressed air may be stored or otherwise maintained with the air storage reservoir 120 as a stored compressed air. In some examples, the cooled compressed air via line 116 may be continuously flowed or otherwise transferred into the air storage reservoir 120 and maintained as the stored compressed air. In other examples, the cooled compressed air via line 116 may be intermittently flowed or otherwise transferred at different times into the air storage reservoir 120. Therefore, the stored compressed air maintained within the air storage reservoir 120 may be or include air from one batch or multiple batches.

During off-peak load periods, (e.g., during a charging mode of the hybrid compressed air energy storage system) one or more compressor units 102 (e.g., the compressor train) may compress air and/or one or more other process gases, and the compressed air or process gas may be introduced to and stored in the air storage reservoir 120. In some nonlimiting examples, the air storage reservoir 120 may be one or more caverns (e.g., underground caverns) or one or more vessels. The air storage reservoir 120 may be or include, but is not limited to, one or more of: a rock cavern, a salt cavern, an aquifer, an abandoned mine, a depleted gas or oil field, a well, a container, tank, or vessel stored underwater or the ground, a container, tank, or vessel stored on, within or above the ground.

One or more thermal storage devices 130 may receive and store the thermal energy via line 132 extracted by the heat exchanger 114 during off-peak load periods (e.g., during the charging mode of the hybrid compressed air energy storage system). A heat transfer medium containing the thermal energy may be flowed or otherwise transferred from the heat exchanger 114 to the thermal storage device 130. The heat transfer medium containing the thermal energy may be maintained in the thermal storage device 130 until used during peak load periods. Alternatively, the thermal energy may be transferred from the heat transfer medium to a thermal mass contained within the thermal storage device 130.

In some examples, not shown, if the hybrid CAES system 100 includes a compressor train, one or more additional heat exchangers 114 may be disposed between each stage or compressor unit 102 containing one or more drivers 106 and one or more compressors 110. Each additional heat exchanger 114 may be disposed downstream of each compressor 110 and may the cooled compressed air or other process gas to the air storage reservoir 120 and may transfer extracted thermal energy to the thermal storage device 130. For example, the hybrid CAES system 100 may include (not shown) a first heat exchanger downstream of a first compressor driven by a first driver, a second heat exchanger downstream of a second compressor driven by a second driver, a third heat exchanger downstream of a third compressor driven by a third driver, and a fourth heat exchanger downstream of a fourth compressor driven by a fourth driver.

In one or more embodiments, during peak load periods, (e.g., during the electric power generation mode of the hybrid compressed air energy storage system) one or more heat exchangers 124 may receive the stored thermal energy via line 134 from the thermal storage device 130 and may also receive the stored compressed air from the air storage reservoir 120 via line 122. The heat exchanger 124 may transfer the stored thermal energy from the heat transfer medium via line 134 to the stored compressed air via line 122 to produce and may discharge a heated compressed air via line 126 and a cooled heat transfer medium via line 136.

The cooled heat transfer medium may be stored and/or may be transferred to the heat exchanger 114 via line 136. The heat transfer medium may be circulated in a thermal cycle between the heat exchanger 114, the thermal storage device 130, and the heat exchanger 124. Each of the heat exchangers 114, 124, as well as any other heat exchanger described and discussed herein, may be or include, but is not limited to, one or more of: a coil system, a shell-and-tube system, a direct contact system, or another type of heat transfer system.

The heat transfer medium may flow through the heat exchanger 114 and absorb thermal energy from the air or other process gas. Thus, the heat transfer medium has a greater temperature when exiting the heat exchanger 114 than when entering the heat exchanger 114; therefore, the heat transfer medium is heated within the heat exchanger 114 by the compressed air or other process gas via line 112. Also, the cooled compressed air or process gas via line 116 has a lower temperature when exiting the heat exchanger 114 than the compressed air via line 112 entering the heat exchanger 114; therefore, the compressed air is cooled within the heat exchanger 114 by the heat transfer medium via line 136.

Heat transfer mediums may be or include one or more working fluids or refrigerants and/or one or more liquid coolants. Illustrative heat transfer mediums may be or include, but are not limited to, water, steam, carbon dioxide, methane, ethane, propane, butane, other alkanes, ethylene glycol, propylene glycol, other glycol ethers, other organic solvents or fluids, one or more hydrofluorocarbons, one or more chlorofluorocarbons, or any combination thereof. One or more thermal masses contained within the thermal storage device 130 may store the extracted thermal energy and may release the stored thermal energy. The thermal mass may be in a solid state, a molten state, a liquid state, a fluid state, a superfluid state, a gaseous state, or any combination thereof. Illustrative thermal masses may be or include, but are not limited to, water, oil, earth, mud, rocks, stones, concrete, metals, salts, or any combination thereof. In some examples, the thermal storage device 130 may be or include the thermal mass disposed within an insulated vessel or other container.

In other embodiments, not shown, during peak load periods, (e.g., during the electric power generation mode) the stored compressed air from the air storage reservoir 120 may be transferred to the thermal storage device 130. The stored compressed air may be heated by the thermal mass contained within the thermal storage device 130. The stored thermal energy in the thermal mass may be transferred to the stored compressed air to produce the heated compressed air. The stored thermal energy may be transferred to the stored compressed air by direct contact, or indirect contact (e.g., a heat exchanger), with the thermal mass.

During peak load periods, (e.g., during the electric power generation mode) the stored compressed air from the air storage reservoir 120 via line 122 may be drawn from the air storage reservoir 120, heated by the heat exchanger 124 to produce the heated compressed air via line 126, and used to power one or more expanders 140. The expander 140 may receive the heated compressed air discharged from the heat exchanger 124. Expander 140 may be arranged to operate in a first pressure range.

Without limitation, this first pressure range is selected to accommodate pressure levels of the cooled compressed air stored in the air storage reservoir 120. Without limitation, depending on factors such as structural characteristics of air storage reservoir 120, depth of air storage reservoir 120, etc., in certain non-limiting applications the pressure level of the cooled compressed air stored in the air storage reservoir 120 could be as high as approximately 2500-2700 psi. In other non-limiting applications, the pressure level of the cooled compressed air stored in the air storage reservoir 120 may be relatively lower, such as in the order of approximately 750-1500 psi. In the first illustrated application, an expander train may be formed by three expanders to transition from the pressure levels that may be as high as 2500-2700 psi to pressure levels approximate to or equal to standard atmospheric pressure. In this application, expander 140 would be a relatively higher-pressure expander compared to the other two expanders in the expander train. In the second application, the expander train may be formed by just two expanders to transition from pressure levels that may be in the order of approximately 750-1500 psi to pressure levels approximate to or equal to standard atmospheric pressure.

The expander 140 may expand the heated compressed air and may discharge an expanded air via line 144. In some examples, the thermal energy transferred from the thermal storage device 130 may be the only thermal energy used to heat or otherwise increase the temperature of the heated compressed air expanded by the expander 140.

The expander 140 may generate or otherwise produce power due to the expansion of the heated compressed air. In one or more examples, the expander 140 may produce electricity by powering one or more electrical generators 142 coupled thereto by one or more driveshafts 141. The electrical generator 142 may generate electricity and upload or otherwise transfer the generated electricity to an electrical grid 103 via line 143 during peak load periods. In one or more examples, at least a portion of the generated electricity may be transferred from the electrical grid 103 via line 105 to one or more drivers 106, as shown, or may be transferred directly from the electrical generator 142 to one or more drivers 106 or other electrical devices, not shown. In other examples, not shown, the expander 140 may be coupled to and power or otherwise drive one or more pumps, one or more compressors, and/or pieces of other process equipment.

One or more recuperators 146 may receive the expander air via line 144, heat the expanded air, and discharge a heated expanded air via line 148. The recuperator 146 may also receive an expanded exhaust gas via line 184, cool the expanded exhaust gas, and discharge a cooled exhaust gas via line 186. For example, the cooled exhaust gas may be vented or otherwise released into the ambient atmosphere. The thermal energy in the expanded exhaust gas via line 184 may be transferred by the recuperator 146 to the expanded air via line 144 to produce the heated expanded air via line 148.

Although not shown, the recuperator 146 may include a cooling portion and a heating portion. The recuperator 146 may transfer thermal energy from the cooling portion to the heating portion. More specifically, the recuperator 146 may transfer thermal energy from heated fluids or gases contained in the cooling portion to other fluids or gases contained in the heating portion. The recuperator 146 may be configured to transfer thermal energy from the expanded exhaust gas to the heated expanded air. For example, the cooling portion of the recuperator 146 may receive the expanded exhaust gas via line 184 and discharge the cooled exhaust gas via line 186, and the heating portion of the recuperator 146 may receive the first expanded air via line 144 and may discharge the heated expanded air via line 148.

In one or more embodiments, the expander 140 may be fluidly coupled to and disposed between the heat exchanger 124 and the recuperator 146, such as, for example, downstream of the heat exchanger 124 and upstream of the recuperator 146. The expander 140 may be used to increase the amount of thermal energy (heat of compression) that is recovered as electricity by the electrical generator 142 and may be used to reduce the temperature of the expanded air discharged from the expander 140.

A technical advantage of disclosed embodiments may be conceptualized as follows: the less thermal energy contained in the expanded air introduced into the recuperator 146 via line 144, the more thermal energy may be transferred from the expanded exhaust gas in line 184 to the heated expanded air in line 148 by the recuperator 146. By increasing the thermal energy transfer from the expanded exhaust gas via line 144 by the recuperator 146, less thermal energy would be lost or otherwise discharged with the cooled exhaust gas via line 186 outside of the hybrid CAES system 100.

The hybrid CAES system 100 may include one or more diabatic power generation units 170. The arrangement of expander 140 between heat exchanger 124 and recuperator 146 enables the adiabatic and diabatic portions of the system to be linked to one another while preserving the technical benefits of either portion, and avoiding concomitant detriments, effectively creating an efficient and environmentally friendly hybrid system.

Each of the power generation units 170 may include one or more combustors 172, one or more expanders 180, and one or more electrical generators 182. In this embodiment, expander 180 may be arranged to operate in a second pressure range, which is lower than the first pressure range of expander 140. As noted above, in this embodiment, the expander train may be formed by expanders 140 and 180 (i.e., just two expanders), which is effective to transition from pressure levels that may be in the order of approximately 750 psi-1500 psi (e.g., by expander 140) to a pressure level approximate to or equal to standard atmospheric pressure (e.g., by expander 180).

The heated expanded air via line 148 may be transferred to the combustor 172. One or more fuels, water, steam, one or more oxygen sources, additives, or any mixture thereof may be added or otherwise transferred to the combustor 172 via line 174 and combined with the heated expanded air in the combustor 172 to produce the fuel mixture. Alternatively, in another embodiment, the one or more fuels, water, steam, oxygen sources (e.g., 02), and/or additives may be combined and mixed with the heated expanded air within the line 148 to produce the fuel mixture upstream of the combustor 172 (not shown). The fuel mixture containing the heated expanded air may be combusted within the combustor 172 to produce an exhaust gas. Illustrative fuels may be or include, but are not limited to, one or more hydrocarbon fuels (e.g., alkanes, alkenes, alkynes, or alcohols), hydrogen gas, syngas, or any combination thereof. Illustrative hydrocarbon fuels may be or include, but are not limited to, methane, ethane, acetylene, propane, butane, gasoline, kerosene, diesel, fuel oil, biodiesel, methanol, ethanol, or any mixture thereof.

Once the fuel mixture is combusted, the combustor 172 may discharge the exhaust gas via line 176 that is transferred to the expander 180. The expander 180 may receive and expand the exhaust gas via line 176 discharged by the combustor 172. The expander 180 may expand the exhaust gas to generate or otherwise produce power. In one or more examples, the expander 180 may produce electricity by powering or driving one or more electrical generators 182 coupled thereto by one or more driveshafts 181. The electrical generator 182 may generate electricity and upload or otherwise transfer the generated electricity to the electrical grid 103 via line 101 during peak load periods. In other examples, the expander 180 may be coupled to and power one or more pumps, one or more compressors, other rotary equipment, and/or other components that may be contained within the hybrid CAES system 100 or other systems (not shown).

The expander 180 may discharge an expanded exhaust gas via line 184. The expanded exhaust gas may have a temperature in a range from about 600° F. (316° C.) to about 1,200° F. (649° C.). The recuperator 146 may receive and cool the expanded exhaust gas via line 184 and may discharge the cooled exhaust gas via line 186. For example, the cooled exhaust gas may be discharged into the ambient atmosphere or transferred to other components contained within the hybrid CAES system 100 or other systems (not shown). In one non-limiting embodiment, the cooled exhaust gas may have a temperature in a range from approximately 212° F. (100° C.) to approximately 550° F. (288° C.). In another non-limiting embodiment, the cooled exhaust gas may have a temperature in a range from approximately 300° F. (149° C.) to approximately 500° F. (260° C.).

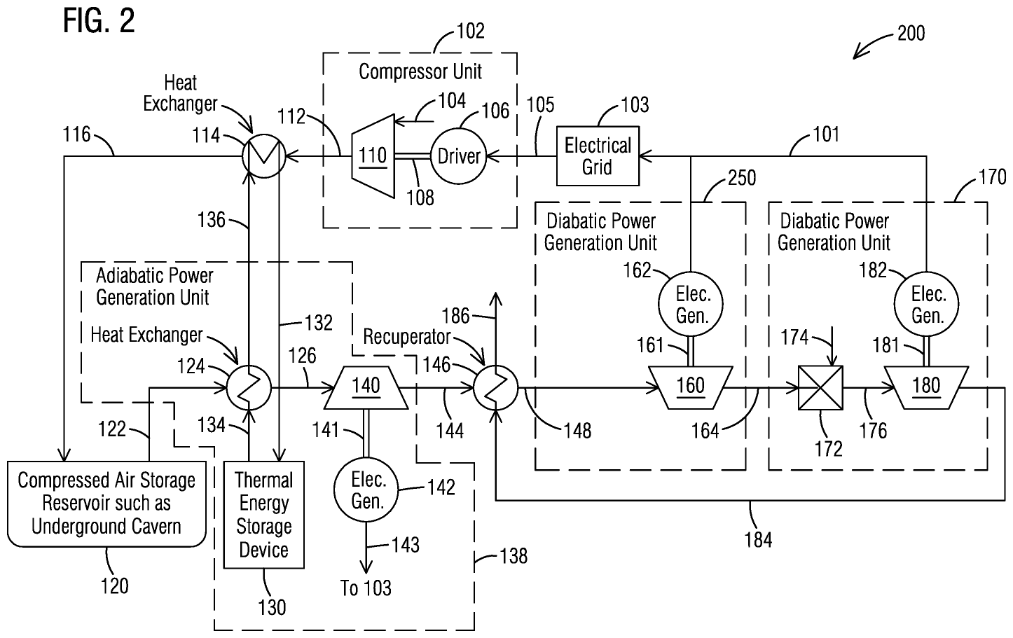

FIG. 2 depicts a schematic diagram of an illustrative hybrid CAES system 200 that may include one or more diabatic power generation units 250 fluidly coupled to and disposed between the recuperator 146 and the diabatic power generation unit 170, such as, for example, downstream of the recuperator 146 and upstream of diabatic power generation unit 170.

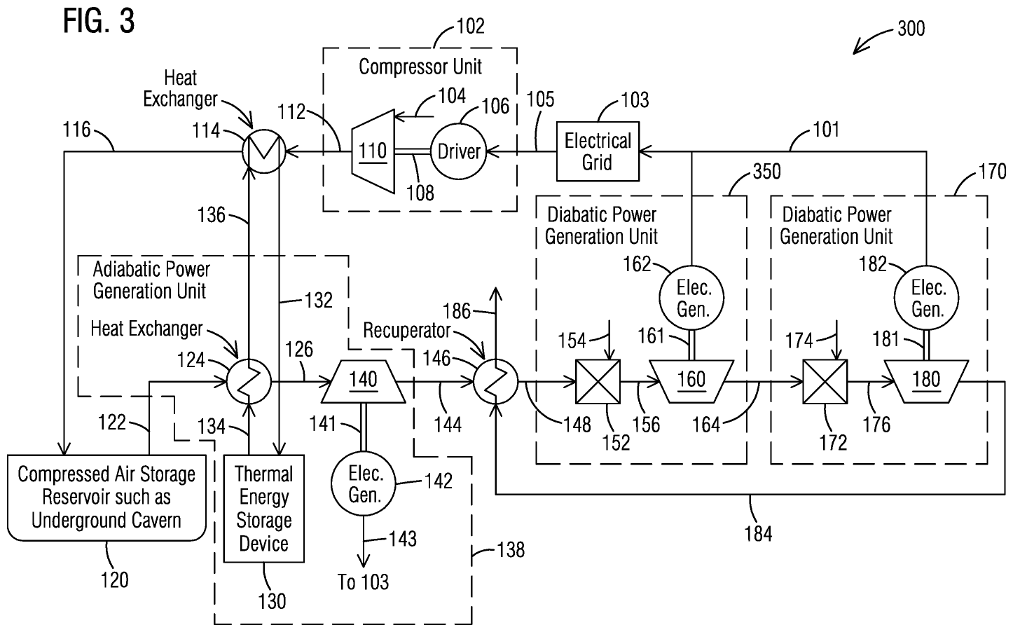

FIG. 3 depicts a schematic diagram of an illustrative hybrid CAES system 300 that may include one or more power generation units 350 disposed downstream of the recuperator 146 and upstream of the power generation unit 170. Each hybrid CAES system 200, 300 may be a hybrid adiabatic-diabatic CAES system that may have aspects of an adiabatic CAES system and a diabatic CAES system. The hybrid CAES systems 200, 300 or portions thereof depicted in FIGS. 2 and 3, respectively, and the hybrid CAES system 100 or portions thereof depicted FIG. 1 share many common components. It should be noted that like numerals shown in the FIGs. and discussed herein represent like components throughout the multiple embodiments disclosed herein.

Each of the diabatic power generation units 250, 350 may include one or more expanders 160 and one or more electrical generators 162, as depicted in FIGS. 2 and 3. The expander 160 may be or include one or more high pressure (HP) expanders. As noted above, in this embodiment, the expander train may be formed by expanders 140, 160 and 180 (i.e., three expanders), which is effective to transition from pressure levels that may be as high as 2500-2700 psi (by expander 140) to an intermediate pressure level (by expander 160) to a pressure level approximate to or equal to standard atmospheric pressure (by expander 180).

The diabatic power generation unit 350, depicted in FIG. 3, may also include one or more combustors 152 fluidly coupled to and disposed between the recuperator 146 and the expander 160, such as, for example, downstream of the recuperator 146 and upstream of the expander 160.

It will be appreciated that the combustors could be either directly-fired, as shown in the schematic, or indirectly-fired where external combustion produces heat which is then conducted into the working fluid (e.g., air). It is contemplated this feature to be an optional implementation in combustor 152 in FIG. 3, but it does not rule out that, based on the needs of a given application, this could be optionally implemented in other combustors.

In one or more embodiments, as depicted in FIG. 2, the expander 160 may receive via line 148 one or more heated expanded process gases, such as heated expanded air, discharged by the recuperator 146. The expander 160 may expand the heated expanded process gas or air to generate or otherwise produce power and may discharge one or more expanded process gases, such as expanded air, via line 164.

In one or more examples, the expander 160 may produce electricity by powering or driving one or more electrical generators 162 coupled thereto by one or more driveshafts 161. The electrical generator 162 may generate electricity and upload or otherwise transfer the generated electricity to the electrical grid 103 via line 101 during peak load periods. In other examples, the expander 160 may be coupled to and power one or more pumps, one or more compressors, other rotary equipment, and/or other components that may be contained within the hybrid CAES systems 200, 300 or other systems (not shown).

In other embodiments, as depicted in FIG. 3, the combustor 152 may receive one or more heated expanded process gases, such as heated expanded air, via line 148 discharged by the recuperator 146. The combustor 152 may discharge an exhaust gas that may be received by the expander 160 via line 156. The expander 160 may expand the exhaust gas or other expanded process gas to generate or otherwise produce power and may discharge one or more expanded exhaust gases via line 164.

The heated expanded air may be transferred to the combustor 152 via line 148. One or more fuels, water, steam, one or more oxygen sources, additives, or any mixture thereof may be added or otherwise transferred to the combustor 152 via line 154 and combined with the heated expanded air in the combustor 152 to produce the fuel mixture. Alternatively, in another embodiment, the one or more fuels, water, steam, oxygen sources (e.g., 02), and/or additives may be combined and mixed with the heated expanded air within the line 148 to produce the fuel mixture upstream of the combustor 152 (not shown). The fuel mixture containing the heated expanded air may be combusted within the combustor 152 to produce an exhaust gas. Illustrative fuels may be or include, but are not limited to, one or more hydrocarbon fuels (e.g., alkanes, alkenes, alkynes, or alcohols), hydrogen gas, syngas, or any combination thereof. Illustrative hydrocarbon fuels may be or include, but are not limited to, methane, ethane, acetylene, propane, butane, gasoline, kerosene, diesel, fuel oil, biodiesel, methanol, ethanol, or any mixture thereof.

Once the fuel mixture is combusted, the combustor 152 may discharge the exhaust gas that is transferred to the expander 160 via line 156. The expanded process gas may be transferred to the one or more combustors 172 via line 164 and combusted as discussed and described above. The expanded process gas may be or include, but is not limited to, air, exhaust gas, working fluid, or any mixture thereof. In one or more examples, the expanded process gas may be or include expanded air and may be discharged from the power generation unit 250 via line 164. In other examples, the expanded process gas may be or include expanded exhaust gas and may be discharged from the power generation unit 350 via line 164.

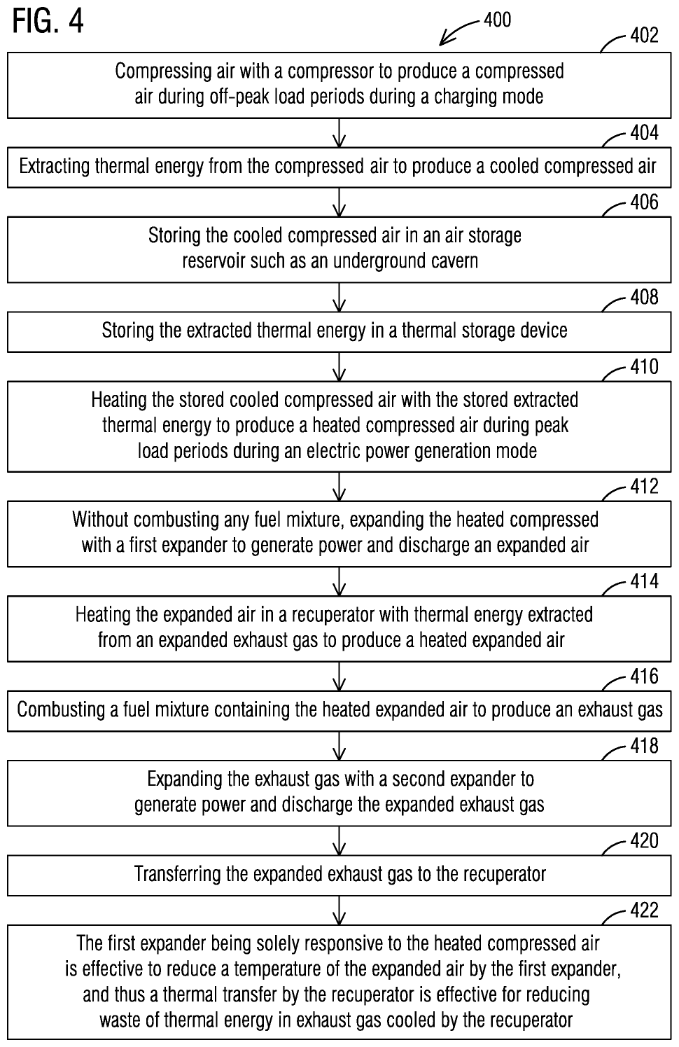

FIG. 4 depicts a flow chart of illustrative method 400 for storing and recovering energy with a hybrid CAES system, according to one or more embodiments. In some embodiments, the method 400 may be conducted on the hybrid CAES system 100, 200, and 300. The method 400 may include compressing air or process gas with one or more compressors to produce a compressed air or process gas during one or more off-peak load periods (e.g., during the charging mode of the hybrid compressed air energy storage system), as shown at 402, and extracting thermal energy from the compressed air or process gas to produce a cooled compressed air or process gas, as shown at 404. The one or more compressors producing the compressed air or process gas may be powered by electricity transferred from an electrical grid during the one or more off-peak load periods.

The method 400 may also include storing the cooled compressed air or process gas in one or more air storage reservoirs, as shown at 406, and storing the extracted thermal energy in one or more thermal storage devices, as shown at 408. The method 400 may further include heating the stored cooled compressed air or process gas with the stored extracted thermal energy to produce a heated compressed air or process gas during one or more peak load periods (e.g., during the electric power generation mode), as shown at 410. The method 400 may also include, without combusting any fuel mixture, expanding the heated compressed air or process gas with one or more first expanders to generate power and discharge an expanded air or process gas, as shown at 412.

The method 400 may further include heating the expanded air or process gas with one or more recuperators to produce a heated expanded air or process gas, as shown at 414. The expanded air or process gas may be heated by thermal energy extracted from one or more expanded exhaust gases that may be passing through the one or more recuperators. The method 400 may include combusting a fuel mixture containing the heated expanded air or process gas to produce an exhaust gas, as shown at 416.

The method 400 may also include expanding the exhaust gas with one or more second expanders to generate power and discharge the expanded exhaust gas, as shown at 418, and transferring the expanded exhaust gas to the one or more recuperators, as shown at 420.

As shown at 422, first expander 140 being solely responsive to heated compressed air (e.g., by second heat exchanger 124 (FIG. 1); i.e., without combusting any fuel mixture), is effective to reduce a temperature of the expanded air by first expander 140, and thus a transfer of thermal energy from the transferred expanded exhaust gas (to heat the expanded air by the first expander) is effective for reducing waste of thermal energy in exhaust gas cooled by recuperator 146.

The expanded exhaust gases may be cooled in the recuperator to produce a cooled exhaust gas that may be vented into the ambient environment. The first expander may be coupled to one or more first electrical generators and the second expander may be coupled to one or more second electrical generators. The power generated by each of the first and second expanders may be used to produce electricity with the first and second electrical generators, respectively. Each of the first electrical generator, the second electrical generator, and one or more additional electrical generators may independently be coupled to the electrical grid and may upload or otherwise transfer the produced electricity to the electrical grid during the one or more peak load periods.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the scope of the present disclosure, and that they may make various changes, substitutions and alterations herein without departing from the scope of the present disclosure.

What is claimed is:

1. A hybrid compressed air energy storage system, comprising:
a compressor responsive to a driver to generate a compressed air during a charging mode of the hybrid compressed air energy storage system;
a first heat exchanger configured to receive the compressed air by the compressor, extract thermal energy from the compressed air by the compressor, and generate a cooled compressed air, wherein the cooled compressed air by the first heat exchanger is conveyed to an air storage reservoir for storage;
a thermal storage device arranged to receive and store the thermal energy extracted by the first heat exchanger;
a second heat exchanger arranged to transfer thermal energy stored by the thermal storage device to cooled compressed air that, during an electric power generation mode of the hybrid compressed air energy storage system, is conveyed from the air storage reservoir to the second heat exchanger to generate a heated compressed air;
a first expander solely responsive to the heated compressed air by the second heat exchanger to produce power and generate an expanded air;
a recuperator arranged downstream of the first expander to receive the expanded air by the first expander and establish thermal transfer between received expanded air and an expanded exhaust gas received by the recuperator, the thermal transfer by the recuperator effective to transfer thermal energy from the received expanded exhaust gas to heat the expanded air by the first expander and in turn cool the received expanded exhaust gas to generated a cooled exhaust gas;
a first combustor arranged to receive the heated expanded air by the recuperator and generate an exhaust gas; and
a second expander responsive to the exhaust gas by the first combustor to produce further power, the second expander being the source of the expanded exhaust gas received by the recuperator,
wherein the first expander being solely responsive to the heated compressed air by the second heat exchanger is effective to reduce a temperature of the expanded air by the first expander, and thereby the transfer of thermal energy from the received expanded exhaust gas to heat the expanded air by the first expander is effective for reducing waste of thermal energy in the cooled exhaust gas by the recuperator.

2. The system of claim 1, wherein the first expander is arranged to operate in a first pressure range, wherein the first expander is coupled to drive a first electrical generator.

3. The system of claim 2, wherein the second expander is arranged to operate in a second pressure range, which is lower than the first pressure range, wherein the second expander is coupled to drive a second electrical generator.

4. The system of claim 3, wherein the first pressure range accommodates pressure levels of the cooled compressed air stored in the air storage reservoir and the second pressure range accommodates ambient atmospheric pressure.

5. The system of claim 1, wherein the thermal transfer by the recuperator is effective so that the cooled exhaust gas by the recuperator comprises a temperature in a range from approximately 212° F. (100° C.) to approximately 550° F. (288° C.).

6. The system of claim 1, wherein the first combustor is arranged to combust a fuel mixture comprising the heated expanded air by the recuperator and a hydrocarbon fuel.

7. The system of claim 1, further comprising a third expander fluidly coupled between the recuperator and the first combustor, wherein the third expander is configured to receive and expand the heated expanded air by the recuperator.

8. The system of claim 7, wherein the third expander is arranged to operate in a third pressure range, which is between the first pressure range and the second pressure range, wherein the third expander is coupled to drive a third electrical generator.

9. The system of claim 7, further comprising a second combustor fluidly coupled between the recuperator and the third expander.

10. The system of claim 1, wherein the driver comprises an electric motor or a turbine.

11. The system of claim 1, wherein the air storage reservoir comprises an underground cavern.

12. The system of claim 1, wherein the recuperator comprises a cooling portion and a heating portion and is arranged to transfer thermal energy between the cooling portion and the heating portion, wherein the cooling portion is arranged to receive the expanded exhaust gas by the second expander and generate the cooled exhaust gas, and wherein the heating portion is configured to receive the expanded air by the first expander and generate the heated expanded air.

13. A hybrid compressed air energy storage system, comprising:
a compressor responsive to a driver to generate a compressed air during a charging mode of the hybrid compressed air energy storage system;
a first heat exchanger configured to receive the compressed air by the compressor, extract thermal energy from the compressed air by the compressor, and generate a cooled compressed air, wherein the cooled compressed air by the first heat exchanger is conveyed to an air storage reservoir for storage;
a thermal storage device arranged to receive and store the thermal energy extracted by the first heat exchanger;
a second heat exchanger arranged to transfer thermal energy stored by the thermal storage device to cooled compressed air that, during an electric power generation mode of the hybrid compressed air energy storage system, is conveyed from the air storage reservoir to the second heat exchanger to generate a heated compressed air;
a first expander solely responsive to the heated compressed air by the second heat exchanger to produce power, and generate an expanded air;
a recuperator arranged downstream of the first expander to receive the expanded air by the first expander and establish thermal transfer between the received expanded air and a second expanded exhaust gas received by the recuperator, the thermal transfer by the recuperator effective to transfer thermal energy from the received second expanded exhaust gas to heat the expanded air by the first expander and in turn cool the received second expanded exhaust gas to generated a cooled exhaust gas;
a first combustor arranged to receive the heated expanded air by the recuperator, combust a first fuel mixture including the heated expanded air by the recuperator and generate a first exhaust gas;
a second expander responsive to the first exhaust gas by the first combustor to produce further power and generate a first expanded exhaust gas;
a second combustor arranged to receive the first expanded exhaust gas by the second expander, combust a second fuel mixture including the first expanded exhaust gas by the second expander and generate a second exhaust gas; and
a third expander responsive to the second exhaust gas by the second combustor to produce still further power, the third expander being the source of the second expanded exhaust gas received by the recuperator,
wherein the first expander being solely responsive to the heated compressed air by the second heat exchanger is effective to reduce a temperature of the expanded air by the first expander, and thereby the transfer of thermal energy from the received second expanded exhaust gas to heat the expanded air by the first expander is effective for reducing waste of thermal energy in the cooled exhaust gas by the recuperator.

14. The system of claim 13, wherein the first expander is arranged to operate in a first pressure range, the second expander is arranged to operate in a second pressure range and the third expander is arranged to operate in a third pressure range, wherein the first pressure range comprises higher pressure values relative to pressure values in the third pressure range, and wherein the second pressure range comprises pressure values between the respective pressure values of the first and third pressure ranges.

15. The system of claim 14, wherein the first pressure range accommodates pressure levels of the cooled compressed air stored in the air storage reservoir and the third pressure range accommodates ambient atmospheric pressure.

16. The system of claim 14, wherein the first, second and third expanders is each respectively coupled to drive respective electrical generators.
